(19) United States
(12) Patent Application Publication
(10) Pub. No.: US 2026/0368774 A1
(43) Pub. Date: Nov. 19, 2026

(54) INCENTIVE PROVISION METHOD AND RECORDING MEDIUM

(71) Applicant: Panasonic Intellectual Property Management Co., Ltd., Osaka (JP)

(72) Inventors: Junya OGAWA, Osaka (JP); Katsuhiko HIRAMATSU, Kanagawa (JP)

(21) Appl. No.: 19/148,241

(22) PCT Filed: Jan. 24, 2024
(86) PCT No.: PCT/JP2024/002102

§ 371 Date: Jul. 15, 2025

(30) Foreign Application Priority Data
Feb. 22, 2023 (JP) 2023-026621

(51) Int. Cl. G06Q 30/0207; G06Q 30/018

(52) U.S. Cl. CPC G06Q 30/0224; G06Q 30/018

(57) ABSTRACT

An incentive provision method includes: calculating an emission amount of greenhouse gas generated by a target person while working from home; and providing an incentive to the target person in accordance with a difference between the emission amount calculated and a reference value, when the emission amount calculated is smaller than the reference value.

### TECHNICAL FIELD

The present invention relates to an incentive provision method and a program.

### BACKGROUND ART

Due to the impact of the spread of the new coronavirus, flexible working styles that enable people to work from anywhere are becoming widespread. For example, in the ASEAN region, where traffic congestion during commuting hours is a problem, many companies are adopting teleworking to reduce loss of time caused by commuting. As a technology related to teleworking, Patent Literature (PTL) 1 discloses a calculation device that calculates the teleworking population on a region-by-region basis.

### CITATION LIST

### Patent Literature

[PTL 1] Japanese Unexamined Patent Application Publication No. 2018-156307

### SUMMARY OF INVENTION

### Technical Problem

Since greenhouse gases such as carbon dioxide can be a cause of global warming, companies are working to reduce the emission amount of greenhouse gases. In relation to such effort, not only the greenhouse gas emissions from companies themselves, but also supply chain emissions have been proposed, which are the total emissions of all greenhouse gases related to business activities of the companies.

The present invention provides an incentive provision method and a program capable of reducing greenhouse gases generated by an employee while working from home.

An incentive provision method according to an aspect of the present invention is an incentive provision method executed by a computer, the incentive provision method including: calculating an emission amount of greenhouse gas generated by a target person while working from home; and providing an incentive to the target person in accordance with a difference between the emission amount calculated and a reference value, when the emission amount calculated is smaller than the reference value.

A program according to an aspect of the present invention is a program for causing a computer to execute the foregoing incentive provision method.

### Advantageous Effects of Invention

The incentive provision method and the program according to an aspect of the present invention are capable of reducing greenhouse gases generated by an employee while working from home.

### BRIEF DESCRIPTION OF DRAWINGS

FIG. 1 is a block diagram showing the functional configuration of an incentive provision system according to an embodiment.

FIG. 2 is a diagram showing the expenses and the emission amounts of greenhouse gases of a company.

FIG. 3 is a sequence diagram showing an example of an operation of calculating a reference value of the emission amount of greenhouse gases.

FIG. 4 is a diagram showing an overview of an operation of providing an incentive.

FIG. 5 is a sequence diagram showing an example of the operation of providing an incentive to a target person.

FIG. 6 is a diagram showing allowances paid to the target person.

FIG. 7 is a diagram showing an example of an image showing the result of providing an incentive.

FIG. 8 is a schematic diagram showing the internal configuration of a private booth unit.

### DESCRIPTION OF EMBODIMENT

Hereinafter, a certain exemplary embodiment is described in greater detail with reference to the accompanying Drawings. The exemplary embodiment described below shows a general or specific example. The numerical values, shapes, materials, elements, the arrangement and connection of the elements, steps, the processing order of the steps etc. shown in the following exemplary embodiment are mere examples, and thus do not limit the scope of the present invention. Therefore, among the elements in the following exemplary embodiment, those not recited in any one of the independent claims are described as optional elements.

Note that the drawings are not always exactly illustrated. Also, the same reference signs are assigned to substantially the same elements throughout the drawings, and overlapping descriptions can be omitted or simplified.

### EMBODIMENT

### Configuration

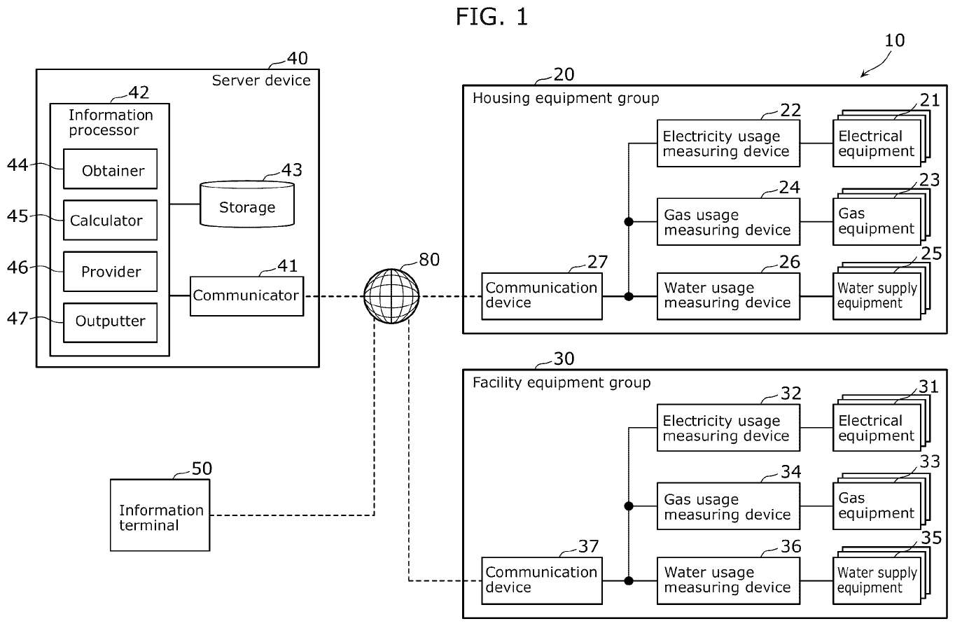

First, the configuration of the incentive provision system according to the embodiment is described. FIG. 1 is a block diagram showing the functional configuration of the incentive provision system according to the embodiment.

Incentive provision system 10 is a system capable of calculating an incentive to be provided to a target person working from home. The target person is one of a plurality of employees working for a company and is a person who is permitted to work from home. Note that the target person may sometimes commute to the facility of the company (e.g., office building) to work. More specifically, incentive provision system 10 includes housing equipment group 20, facility equipment group 30, server device 40, and information terminal 50.

Housing equipment group 20 includes a plurality of pieces of equipment provided in the residence where the target person lives. More specifically, housing equipment group 20 includes at least one piece of electrical equipment 21 (a plurality of pieces of electrical equipment are shown in FIG. 1), electricity usage measuring device 22, at least one piece of gas equipment 23 (a plurality of pieces of gas equipment are shown in FIG. 1), gas usage measuring device 24, at least one piece of water supply equipment 25 (a plurality of pieces of water supply equipment are shown in FIG. 1), water usage measuring device 26, and communication device 27.

At least one piece of electrical equipment 21, which is provided in the residence where the target person lives, is equipment that operates on electrical energy. At least one piece of electrical equipment 21 includes, for example, lighting equipment, ventilation equipment, air-conditioning equipment, and cooking equipment. The lighting equipment includes ambient lighting that illuminates the entire room and task lighting that illuminates the work area of the target person. Also, the cooking equipment includes, for example, an induction cooker (IH cooking heater).

Electricity usage measuring device 22 measures the usage amount of electricity used by at least one piece of electrical equipment 21 (in other words, the amount of electricity consumed). Electricity usage measuring device 22 is, for example, a distribution board having the function of measuring the usage amount of electricity, but may also be a smart meter (electrical energy meter having a communication function).

At least one piece of gas equipment 23, which is provided in the residence, is equipment that operates on gas energy. At least one piece of gas equipment 23 includes, for example, air-conditioning equipment and cooking equipment. An example of the air-conditioning equipment here is a so-called gas heat pump air conditioner. The cooking equipment is, for example, a gas stove.

Gas usage measuring device 24 measures the usage amount of gas used by at least one piece of gas equipment 23. Gas usage measuring device 24 is a so-called gas meter.

At least one piece of water supply equipment 25 is water supply equipment (water pipe and tap) provided in the residence.

Water usage measuring device 26 measures the amount of water released from water supply equipment 25, that is, the usage amount of water used by the target person. Water usage measuring device 26 is a so-called water meter.

Communication device 27 transmits, as measurement information, the measured value of the usage amount of electricity measured by electricity usage measuring device 22, the measured value of the usage amount of gas measured by gas usage measuring device 24, and the measured value of the usage amount of water measured by water usage measuring device 26, to server device 40. More specifically, communication device 27 transmits the measurement information to server device 40 over wide-area communication network 80 such as the Internet. Communication device 27 is realized, for example, in the form of a broadband router.

Facility equipment group 30 includes a plurality of pieces of equipment provided in the facility (e.g., office building) where the target person works. More specifically, facility equipment group 30 includes at least one piece of electrical equipment 31 (a plurality of pieces of electrical equipment are shown FIG. 1), electricity usage measuring device 32, at least one piece of gas equipment 33 (a plurality of pieces of gas equipment are shown in FIG. 1), gas usage measuring device 34, at least one piece of water supply equipment 35 (a plurality of pieces of water supply equipment are shown in FIG. 1), water usage measuring device 36, and communication device 37. If “housing” in the description for housing equipment group 20 is replaced with “facility”, it can be read as the description for facility equipment group 30. As such, the description for each equipment included in facility equipment group 30 is omitted. Note that the actual number of pieces of equipment included in facility equipment group 30 is greater than the number of pieces of equipment included in housing equipment group 20. This point, however, is not exactly illustrated in FIG. 1.

Server device 40 is a cloud server that is provided outside the residence where the target person lives and outside the facility where the target person works. Server device 40 calculates (estimates) the emission amount of greenhouse gases generated by the target person while working from home, on the basis of the items of measurement information received from communication device 27 included in housing equipment group 20. Server device 40 also calculates the reference value of the emission amount of greenhouse gases, on the basis of the items of measurement information received from communication device 37 included in facility equipment group 30. Greenhouse gases refer to, for example, carbon dioxide. More specifically, server device 40 includes communicator 41, information processor 42, and storage 43.

Communicator 41 is a communication circuit used by server device 40 to communicate with communication device 27, communication device 37, and information terminal 50 over wide-area communication network 80. Communicator 41 is, for example, a wired communication circuit for performing wired communication, but may also be a wireless communication circuit for performing wireless communication. The communication standards of commutation performed by communicator 41 are not limited to specific communication standards.

Information processor 42 calculates the emission amount of greenhouse gases using the items of measurement information, and provides an incentive to the target person, on the basis of the calculated emission amount of greenhouse gases. Stated differently, information processor 42 performs information processing related to the providing of an incentive to the target person. Information processor 42 is realized, for example, in the form of a microcomputer, but may also be realized in the form of a processor. Information processor 42 includes, as the functional elements, obtainer 44, calculator 45, provider 46, and outputter 47. The functions of obtainer 44, calculator 45, provider 46, and outputter 47 are realized by, for example, a microcomputer or a processor included in information processor 42 executing a computer program stored in storage 43. More specific functions of obtainer 44, calculator 45, provider 46, and outputter 47 are described later.

Storage 43 is a storage device that stores information required by information processor 42 to perform the foregoing information processing. Such information includes a computer program to be executed by information processor 42. Memory 43 is realized, for example, in the form of a hard disk drive (HDD), but may also be realized in the form of a semiconductor memory.

Information terminal 50 is an information terminal used to access server device 40 by a person who needs to calculate an incentive to be provided to the target person, such as a person in charge of accounting or human resources at the company to which the target person belongs (such person is hereinafter simply referred to also as “manager”). Information terminal 50 is, for example, a stationary information terminal such as a personal computer, but may also be a mobile information terminal such as a smartphone or a tablet terminal.

### Impact of Adopting Teleworking on Company

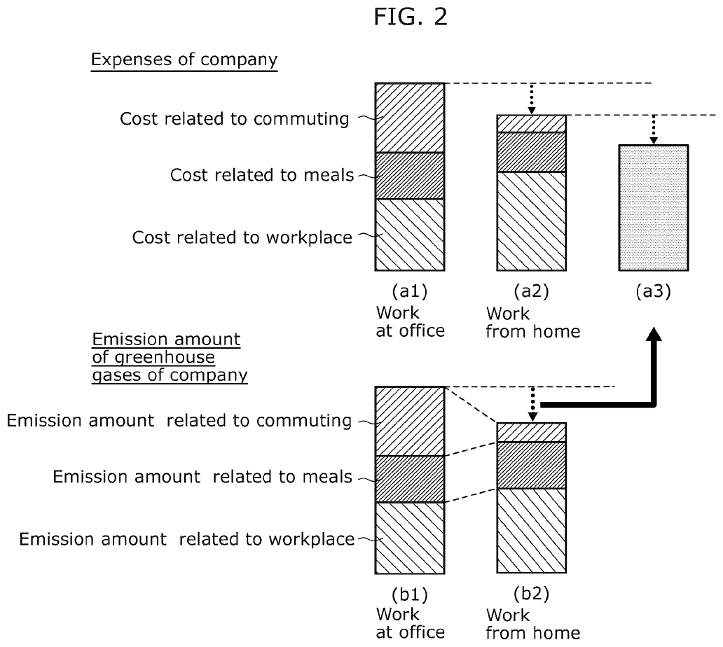

As described above, incentive provision system 10 is a system for calculating an incentive to be provided to the target person working from home. The following describes the impact on the company when teleworking is adopted. FIG. 2 is a diagram showing the expenses and the emission amounts of greenhouse gases of the company.

The expenses of the company illustrated in FIG. 2 refer to the allowances paid by the company to the employees, the running costs of the facility, etc. (a1) in FIG. 2 shows the expenses for the case where the employees belonging to the company commute to the facility (office building) to work, without adopting teleworking. More specifically, possible expenses of the company include the cost related to commuting, the cost related to meals, and the cost related to the workplace.

The cost related to commuting, which is, for example, the transportation expenses paid to the employees, more specifically includes the usage fees for public transportation, the gasoline expenses for commuting by cars, the parking fees for the facility, etc.

The cost related to meals includes, for example, the meal allowances paid to the employees, the rent for the cafeteria space within the facility, the costs of operating the cafeteria (utility costs, shipping costs, and labor costs), etc. The cost related to the workplace includes the rent for the facility, the utility costs for the facility, etc.

(a2) in FIG. 2 shows the expenses for the case where teleworking is adopted. It can be considered from the comparison between (a2) in FIG. 2 and (a1) in FIG. 2 that the cost related to commuting, the cost related to meals, and the cost related to the workplace increase or decrease as the result of adopting teleworking, but that the total expenses are expected to decrease due to a significant reduction in the cost related to commuting.

(b1) in FIG. 2, which corresponds to (a1) in FIG. 2, shows the emission amount of greenhouse gases for the case where teleworking is not adopted. (b2) in FIG. 2, which corresponds to (b1) in FIG. 2, shows the emission amount of greenhouse gases for the case where teleworking is adopted. More specifically, as shown in (b1) and (b2) in FIG. 2, possible emission amounts of greenhouse gases (hereinafter, “greenhouse gases” is abbreviated and simply referred to also as “emission amounts”) of the company include the emission amount related to commuting, the emission amount related to meals, and the emission amount related to the workplace.

The emission amount related to commuting includes, for example, the emission amount of public transportation, the emission amount of cars, the emission amount during the operation and use of the parking lots of the facility, etc.

The emission amount related to meals includes, for example, the emission amount related to meal preparation, the emission amount related to cafeteria operation (including the emission amount related to utility costs), etc. The emission amount related to the workplace includes, for example, the emission amount related to utility costs for the facility.

It can be considered from the comparison between (b2) in FIG. 2 and (b1) in FIG. 2 that the emission amount related to the workplace increases, the emission amount related to meals remains almost the same, and the emission amount related to commuting significantly decreases as a result of adopting teleworking.

It can be considered from above that the company can further reduce the expenses related to greenhouse gas emissions rights from the expenses shown in (a2) in FIG. 2. Since income is obtained from emissions trading, it is possible, for example, to reduce the total expenses even if incentives are paid to the employees. Stated differently, as shown in (a3) in FIG. 2, expenses can be reduced more than that shown in (a2) in FIG. 2. It is thus expected that, the more the employees work from home, the more the expenses of the company decrease. It is thus considered that companies that adopt teleworking will have leeway (financial leeway) to pay incentives to employees working from home.

### Operation of Calculating Reference Value

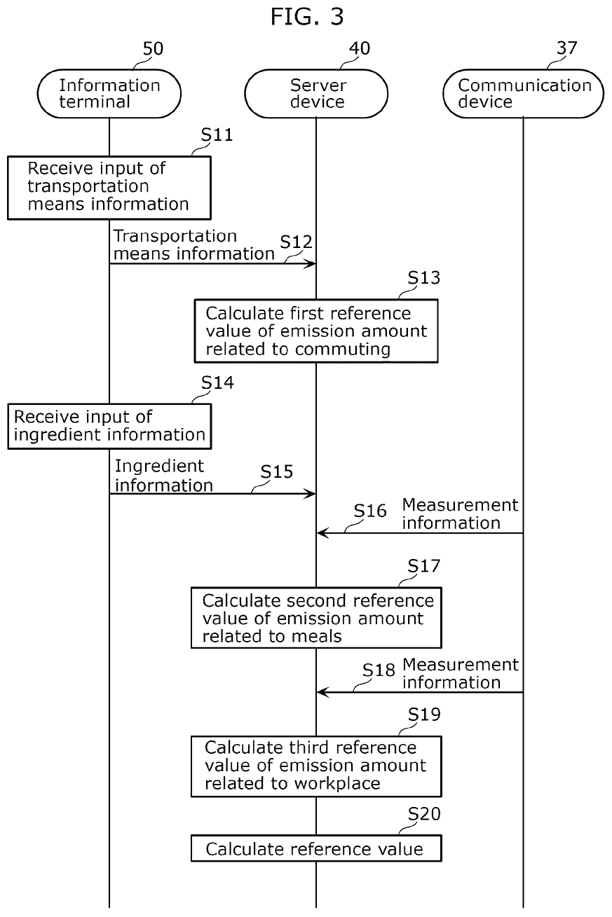

In view of the above, incentive provision system 10 determines an incentive to be provided to the target person, on the basis of the emission amount of greenhouse gases generated by the target person while working from home. Incentive provision system 10 calculates the reference value of the emission amount of greenhouse gases (which is approximately the emission amount per employee converted from the emission amount shown in (b1) in FIG. 2) used to calculate the incentive. FIG. 3 is a sequence diagram showing an example of an operation of calculating the reference value of the emission amount of greenhouse gases.

The administrator of the company, for example, inputs transportation means information to information terminal 50. Information terminal 50 receives the input of the transportation means information (S11), and transmits such transportation means information to server device 40 (S12). The transportation means information is information indicating the means of transportation used for commuting and the distance traveled by such means of transportation for each of the employees who commute to the facility. The means of transportation is selected, for example, from four categories of train, bus, private car, and walking/bicycle. For example, the transportation means information of an employee who commutes by train and walking indicates, for example, that train 15 km, bus 0 km, private car 0 km, and walking/bicycle 2 km. Communicator 41 receives the transportation means information, and obtainer 44 obtains the transportation means information.

Calculator 45 calculates the reference value (first reference value) of the emission amount of greenhouse gases related to commuting, on the basis of the obtained transportation means information (S13). More specifically, calculator 45 aggregates the means of transportation and the distances traveled by such mans of transportation of a plurality of employees who commute to the facility. When all of the employees commute to work, the aggregate results per day to be obtained indicate, for example, that the total distance traveled by trains is a km, the total distance traveled by buses is b km, the total distance traveled by private cars is c km, and the total distance traveled walking/bicycle is d km.

Here, storage 43 preliminarily stores first emission amount information indicating the emission amount of greenhouse gases per kilometer of travel by each means of transportation. The first emission amount information is information indicating, for example, that train 17 g/km, bus 57 g/km, private car 130 g/km, and walking/bicycle 0 g/km.

On the basis of the aggregate results of the transportation means information and the first emission amount information, calculator 45 is capable of calculating the emission amount of greenhouse gases per day as 17×a+57×b+130×c+0×d [g], as the result of all of the plurality of employees commuting to work. By dividing such emission amount by the number of the plurality of employees, it is possible for calculator 45 to calculate the emission amount of greenhouse gases related to commuting for each person per day. Calculator 45 uses such emission amount of greenhouse gases related to commuting for each person per day as the first reference value.

Note that calculator 45 may individually calculate the first reference value for each of the plurality of employees. For example, it is possible to calculate the emission amount of greenhouse gases related to commuting for employee A per day, that is, the individual first reference value for employee A, on the basis of the transportation means information of employee A.

Next, the manager of the company, for example, inputs ingredient information to information terminal 50. Information terminal 50 receives the input of the ingredient information (S14), and transmits the ingredient information to server device 40 (S15). The ingredient information is information indicating the amount of ingredients used in the cafeteria in the facility in one month. Communicator 41 receives the ingredient information, and obtainer 44 obtains the ingredient information.

In addition, communication device 37 in facility equipment group 30 transmits, to server device 40, the items of measurement information indicating the usage amounts of electricity, water, and gas in the cafeteria in the facility, at regular time intervals or in response to a request from server device 40 (S16). Communicator 41 receives the items of measurement information, and obtainer 44 obtains the items of measurement information.

Calculator 45 calculates the reference value (second reference value) of the emission amount of greenhouse gases related to meals, on the basis of the obtained ingredient information and the obtained items of measurement information (S17).

The emission amount of greenhouse gases related to meals is the total of (a) the emission amount of greenhouse gases generated during the production of the ingredients and (b) the emission amount of greenhouse gases generated during the cooking of the ingredients.

More specifically, calculator 45 calculates the foregoing (a) the emission amount of greenhouse gases generated during the production of the ingredients, on the basis of the ingredient information obtained in step S15 and second emission amount information. The second emission amount information is information that specifies the amount of greenhouse gases generated when each ingredient is produced in a unit amount, and is preliminarily stored in storage 43.

When the ingredient information indicates that 100 kg of a certain ingredient is used in one month, and the second emission amount information specifies that the emission amount of greenhouse gases generated during the production of 1 kg of such ingredient is n [g], for example, the emission amount of greenhouse gases generated during the production of such certain ingredient can be calculated as 100×n [g]. Calculator 45 calculates the emission amounts of greenhouse gases generated during the production of the respective ingredients and totals them, thereby calculating the emission amount of greenhouse gases generated during the production of the ingredients.

Calculator 45 also calculates the foregoing (b) the emission amount of greenhouse gases generated during the cooking of the ingredients, on the basis of the items of measurement information obtained in step S16 and third emission amount information. The third emission amount information is information that specifies the emission amounts of greenhouse gases per unit of electricity, water, and gas usage, and is preliminarily stored in storage 43. The third emission amount information is information indicating, for example, that water 245 g/m³ , gas 2200 g/m³ , and electricity 433 g/kwh.

When the usage amount of water is x m³, the usage amount of gas is y m³, and the usage amount of electricity is z kWh in the cafeteria in one month, for example, the emission amount of greenhouse gases generated during the cooking of the ingredients can be calculated as 245×x+2200×y+433×z [g]. Note that, since the numerical values specified in the third emission amount information vary depending on the region, the numerical values of the third emission amount information used to calculate the reference value can differ from the numerical values of the third emission amount information used to calculate the personal value (to be described later).

Calculator 45 is capable of calculating the emission amount of greenhouse gases related to meals for each person per day by totaling the foregoing (a) the emission amount of greenhouse gases generated during the production of the ingredients and the foregoing (b) the emission amount of greenhouse gases generated during the cooking of the ingredients, which are calculated as described above, and then by dividing the resulting value by the number of days the cafeteria is open in one month (e.g., 20 days) and the number of the plurality of employees. Calculator 45 uses such emission amount of greenhouse gases related to meals for each person per day as the second reference value.

Note that the method of calculating the second reference value as described above assumes that all of the plurality of employees commute to the facility and have meals at the cafeteria during the month. In the case where some of the employees work from home during the month, for example, the second reference value is adjusted assuming that a plurality of employees commute to the facility and have meals at the cafeteria.

Note that the emission amount of greenhouse gases generated during the cooking of the ingredients can be included in the emission amount of greenhouse gases related to the workplace to be described next. Stated differently, the emission amount of greenhouse gases generated during the cooking of the ingredients may be included not in the second reference value but in the third reference value.

Next, communication device 37 in facility equipment group 30 transmits, to server device 40, the items of measurement information indicating the usage amounts of electricity, water, and gas in the entire facility, at regular time intervals or in response to a request from server device 40 (S18). Communicator 41 receives the items of measurement information, and obtainer 44 obtains the items of measurement information. Stated differently, in step S18, the usage amount of energy (electricity and gas) and the usage amount of water in the facility are obtained.

Calculator 45 calculates the reference value (third reference value) of the emission amount of greenhouse gases related to the workplace, on the basis of the obtained items of measurement information (S19). Calculator 45 calculates the emission amount of greenhouse gases related to the workplace, on the basis of the items of measurement information obtained in step S18 and the third emission amount information.

When the usage amount of water is x m³, the usage amount of gas is y m³, and the usage amount of electricity is z kWh in the facility, for example, the emission amount of greenhouse gases in the facility in one month can be calculated as 245×x+2200×y+433×z [g].

Calculator 45 is capable of calculating the emission amount of greenhouse gases related to the workplace for each person per day by dividing the emission amount of greenhouse gases per month, as calculated above, by the number of workdays per month (e.g., 20 days) and the number of the plurality of employees. Calculator 45 uses such emission amount of greenhouse gases related to the workplace for each person per day as the third reference value.

Note that the method of calculating such third reference value assumes that all of the plurality of employees commute to the facility to work during the month. In the case where some of the employees work from home during the month, for example, the third reference value is adjusted assuming that a plurality of employees commute to the facility to work.

Calculator 45 then calculates the reference value of the emission amount of greenhouse gases by adding the first reference value calculated in step S13, the second reference value calculated in step S17, and the third reference value calculated in step S19 (S20). Note that calculator 45 stores the calculated reference value in storage 43.

As described above, the reference value of the emission amount of greenhouse gases is the emission amount of greenhouse gases per person that is calculated assuming that a plurality of employees commute to the facility to work. The reference value of the emission amount of greenhouse gases is calculated, on the basis of the total of the emission amount of greenhouse gases related to commuting, the emission amount of greenhouse gases related to meals, and the emission amount of greenhouse gases related to the workplace.

Note that the reference value of the emission amount of greenhouse gases may be calculated, on the basis of the total of at least one of the emission amount of greenhouse gases related to commuting, the emission amount of greenhouse gases related to meals, or the emission amount of greenhouse gases related to the workplace. For example, the emission amounts of greenhouse gases related to meals may be considered to be the same between the cases where the employees commute to the facility to work and where the employees work from home, and may be excluded from the calculation of the reference value and the calculation of the personal value (to be described later).

### Operation of Providing Incentive to Target Person

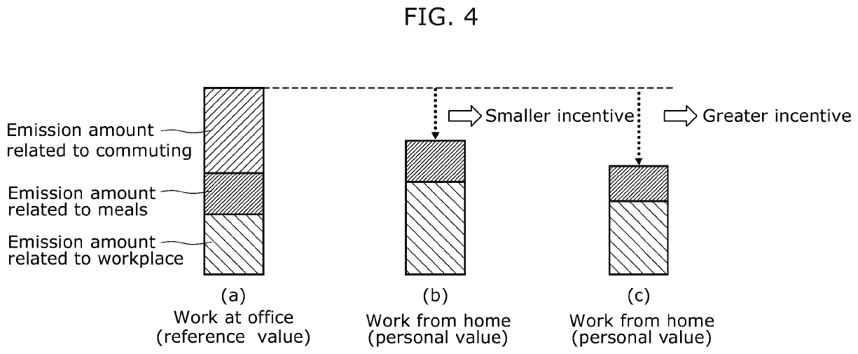

Next, the operation of providing an incentive to the target person is described. FIG. 4 is a diagram showing an overview of the operation of providing an incentive.

(a) in FIG. 4 shows the emission amount of greenhouse gases per day for the case where the target person commutes to the facility (office) to work. This emission amount corresponds to the reference value described above. Meanwhile, (b) in FIG. 4 shows the emission amount of greenhouse gases for the case where the target person works from home (such emission amount is hereinafter also referred to as the “personal value” of the emission amount of greenhouse gases). When the target person reduces the emission amount of greenhouse gases by working from home as shown in (b) in FIG. 4, the target person can receive an incentive.

If the target person reduces the emission amount related to the workplace while working from home as shown in (c) in FIG. 4 (stated differently, the usage amount of water and the usage amount of energy in the residence), the target person can receive a larger amount of incentive. According to incentive provision system 10, it is thus possible to prompt the target person to adopt a house having high thermal insulation performance and adopt electrical equipment having high energy-saving performance.

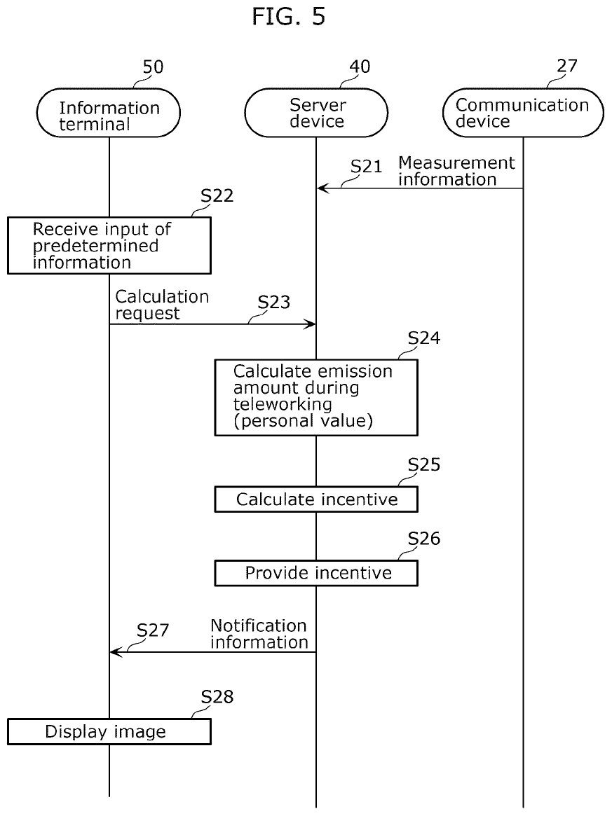

The following specifically describes the operation of providing an incentive to the target person. FIG. 5 is a sequence diagram showing an example of the operation of providing an incentive to the target person.

Communication device 27 in housing equipment group 20 transmits, to server device 40, items of measurement information indicating the usage amounts of electricity, water, and gas in the residence where the target person lives, at regular time intervals or in response to a request from server device 40 (S21). Communicator 41 receives the items of measurement information, and obtainer 44 obtains the items of measurement information. Stated differently, in step S21, the usage amount of energy and the usage amount of water used by the target person while working from home are obtained. As a result, the items of measurement information indicating the usage amounts of electricity, water, and gas in the residence in the most recent month, for example, is stored in storage 43.

The administrator of the company, for example, inputs predetermined information for calculating the incentive for the target person to information terminal 50. Information terminal 50 receives the input of the predetermined information (S22), and transmits, to server device 40, a calculation request for calculating the incentive, including the predetermined information (S23). The predetermined information includes identification information (ID) of the target person, teleworking date information indicating the dates and time periods when the target person work from home in the most recent month, and ingredient information at the time of teleworking. Communicator 41 receives the calculation request (predetermined information), and obtainer 44 obtains the calculation request.

Calculator 45 calculates the emission amount of greenhouse gases generated by the target person while working from home (such emission amount is hereinafter also referred to as the “personal value” of the emission amount of greenhouse gases), on the basis of the obtained calculation request (S24).

The personal value of greenhouse gas emissions is calculated by dividing the total of the emission amount of greenhouse gases related to meals and the emission amount of greenhouse gases related to the workplace by the number of days of teleworking.

First, the method of calculating the emission amount of greenhouse gases related to meals is described. The emission amount of greenhouse gases related to meals is the total of (a) the emission amount of greenhouse gases generated during the production of ingredients and (b) the emission amount of greenhouse gases generated during the cooking of the ingredients.

Calculator 45 calculates (a) the emission amount of greenhouse gases generated during the production of the ingredients, on the basis of the ingredient information included in the calculation request obtained in step S23, and the second emission amount information. Since the description for this calculation method is the same as that for the calculation of the second reference value, a detailed description is omitted.

In addition, calculator 45 calculates (b) the emission amount of greenhouse gases generated during the cooking of the ingredients, on the basis of the items of measurement information obtained in step S21, the teleworking date information included in the calculation request obtained in step S23, and the third emission amount information.

When the usage amount of water in the kitchen and the usage amount of electricity or gas in the induction cooker are separable from the items of measurement information, for example, it is possible for calculator 45 to calculate the emission amount of greenhouse gases generated during the cooking of the ingredients, on the basis of the usage amount of water in the kitchen and the usage amount of electricity or gas in the induction cooker on the dates indicated by the teleworking date information, and the third emission amount information. When such separation is not possible, calculator 45 may calculate the emission amount of greenhouse gases generated during the cooking of the ingredients, on the basis of the usage amounts of water, electricity, and gas during a specific time domain (e.g., 11:30 to 12:00) on the dates indicated by the teleworking date information, and the third emission amount information, assuming that the usage amounts of water, electricity, and gas during such specific time domain are the usage amounts for cooking.

Note that the emission amount of greenhouse gases generated during the cooking of the ingredients can be included in the emission amount of greenhouse gases related to the workplace. Stated differently, it is not necessary to separately calculate the emission amount of greenhouse gases generated during the cooking of the ingredients.

Next, the method of calculating the emission amount of greenhouse gases related to the workplace is described. Calculator 45 calculates the emission amount of greenhouse gases related to the workplace, on the basis of the items of measurement information obtained in step S21, the teleworking date information included in the calculation request obtained in step S23, and the third emission amount information. More specifically, calculator 45 is capable of calculating the emission amount of greenhouse gases related to the workplace, on the basis of the usage amounts of water, electricity, and gas during the time domain in which teleworking is carried out on the dates indicated by the teleworking date information, and the third emission amount information.

Calculator 45 then calculates the emission amount of greenhouse gases per day of teleworking, that is, the personal value of the emission amount of greenhouse gases, by dividing the total of the emission amount of greenhouse gases related to meals and the emission amount of greenhouse gases related to the workplace by the number of days of teleworking indicated by the teleworking date information.

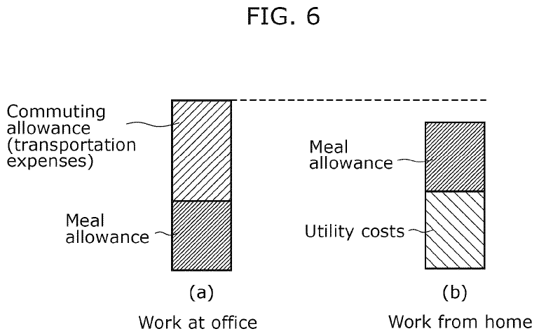

Subsequent to step S24, calculator 45 calculates the incentive to be provided to the target person in accordance with the difference between the calculated personal value and the reference value (the reference value stored in storage 43 as a result of performing the operation shown in FIG. 3) (S25). The incentive is, for example, money provided to the target person. The incentive is, for example, a type of allowance to be paid to the target person. FIG. 6 is a diagram showing allowances paid to the target person.

(a) in FIG. 6 shows allowances to be paid to the target person for the case where the target person commutes to the facility (office) to work, and includes the commuting allowance (transportation expenses) and the meal allowance. (b) in FIG. 6 shows allowances to be paid to the target person for the case where the target person works from home, and includes the meal allowance and the allowance corresponding to utility expenses for teleworking, with no commuting allowance included. An incentive is paid to the target person in addition to these allowances. The incentive is, for example, money that is less than the allowances to be paid to each person ((a) in FIG. 6) to be paid assuming that a plurality of employees commute to the facility to work.

When the calculated personal value is smaller than or equal to the reference value, that is, when teleworking is not considered to contribute to the reduction in greenhouse gases, calculator 45 does not provide an incentive to the target person (sets the incentive to 0). Meanwhile, when the calculated personal value is greater than the reference value, that is, when teleworking is considered to contribute to the reduction in greenhouse gases, calculator 45 sets the incentive per day to a predetermined amount of money, and calculates the incentive by multiplying the predetermined amount of money by the number of days of teleworking. The predetermined amount of money may vary in two or more levels, and may be set to be higher the greater the personal value is than the reference value and the greater the difference between the personal value and the reference value is.

Next, provider 46 provides the incentive to the target person (S26). More specifically, provider 46 stores, in storage 43, the identification information of the target person included in the calculation request obtained in step S23, and the incentive (amount of money) calculated in step S25 in association with each other.

Next, outputter 47 outputs notification information for notifying the results of providing the incentive (S27). Communicator 41 transmits, to information terminal 50, the notification information outputted.

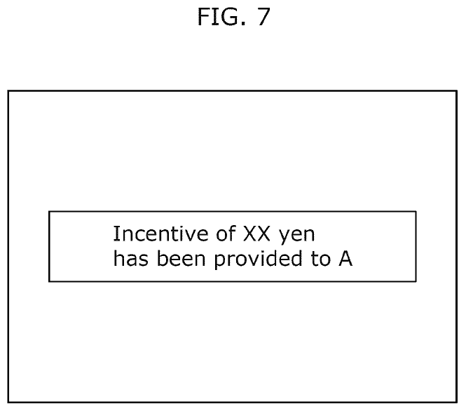

Information terminal 50 receives the notification information, and displays, onto a display of information terminal 50, an image showing the results of providing the incentive, on the basis of the received notification information (S28). FIG. 7 is a diagram showing an example of the image showing the results of providing the incentive.

As described above, incentive provision system 10 includes: calculator 45 that calculates the emission amount of greenhouse gases (personal value) for the case where the target person works from home; and provider 46 that provides an incentive to the target person in accordance with the difference between the calculated emission amount and the reference value, when the calculated emission amount is smaller than the reference value.

According to such incentive provision system 10, it is expected that the target person (one of the plurality of employees belonging to the company) will more actively commit to the provision of data such as measurement information and the reduction in the emission amount of greenhouse gases to receive incentives. Regarding the calculation of supply chain emissions, there is an opinion that the emission amount associated with the lives of the employees of companies, especially the emission amount of greenhouse gases generated during teleworking, should be considered as Scope 4, in addition to the existing Scopes 1 to 3. For this reason, there is a possibility that the supply chain emissions of the company are reduced by the target person more actively reducing the emission amount of greenhouse gases generated during teleworking.

Also, according to incentive provision system 10, since the target person will have a greater benefit from purchasing a house and equipment having excellent energy-saving performance, it is possible to promote the adoption of a house and equipment having excellent energy-saving performance.

As a result of the target person (employee) more actively reducing the emission amount of greenhouse gases, the company can reduce the amount of greenhouse gases generated by the employee, thus reducing the allowances to be paid to the target person (allowances corresponding to utility costs). Stated differently, it becomes possible for the company to reduce the expenses without changing (increasing) expense items regarding accounting. It becomes also possible for the company to receive financial benefits in terms of greenhouse gas emissions trading. It is further possible for the company to keep track of the amount of greenhouse gases generated by the employee while working from home.

Also, the adoption of such incentive system enables the company to be recognized as a company that is taking a progressive approach, and thus to achieve the effects of being able to more easily secure talented human resources.

### Private Booth Unit

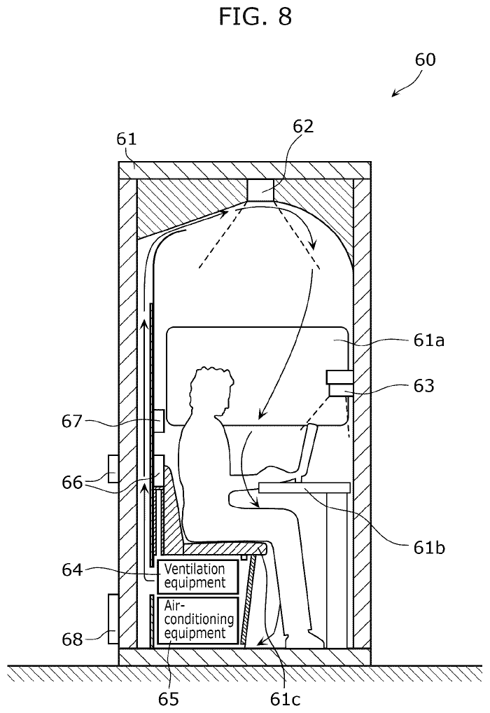

An exclusive private booth unit may be used for teleworking. FIG. 8 is a schematic diagram showing the internal configuration of a private booth unit.

Private booth unit 60 shown in FIG. 8 includes private booth main body 61, ambient lighting 62, task lighting 63, ventilation equipment 64, air-conditioning equipment 65, environmental sensors 66, remote control 67, and electricity usage measuring device 68. The arrows in FIG. 8 show an example of the flow of air inside private booth main body 61.

Private booth main body 61 is a structure that defines the space where the target person occupies when working from home. Private booth main body 61 has a heat insulating structure, thereby achieving relatively high heat insulation performance. Private booth main body 61 also includes window 61a for natural lighting. Also, private booth main body 61 includes therein desk 61b and chair 61c.

Ambient lighting 62 is provided on the ceiling of private booth main body 61, and illuminates the entirety of the interior of private booth main body 61.

Task lighting 63 is provided on the wall surface facing the inside of private booth main body 61, and illuminates the area above desk 61b (work area of the target person).

Ventilation equipment 64 is provided below chair 61c, and lets air in and out between the inside and outside of private booth main body 61.

Air-conditioning equipment 65 is provided below chair 61c, and adjusts the temperature inside private booth main body 61 by releasing temperature-controlled air.

Environmental sensor 66 is provided in each of the inside and the outside of private booth main body 61, and performs sensing of temperature, humidity, carbon dioxide concentration, etc.

Remote control 67 controls ambient lighting 62, task lighting 63, ventilation equipment 64, and air-conditioning equipment 65 in response to, for example, an operation performed by the target person. Remote control 67 is capable of controlling, for example, ON and OFF of ambient lighting 62, task lighting 63, ventilation equipment 64, and air-conditioning equipment 65, the brightness (dimming rate) of ambient lighting 62 and task lighting 63, the ventilation volume of ventilation equipment 64, the preset temperature of air-conditioning equipment 65, etc.

Electricity usage measuring device 68 measures the usage amount of electricity (in other words, the amount of electricity consumed) used by the pieces of electrical equipment provided in the private booth. The pieces of electrical equipment here include ambient lighting 62, task lighting 63, ventilation equipment 64, air-conditioning equipment 65, environmental sensors 66, and remote control 67.

As described above, private booth unit 60 includes, in an integrated manner, private booth main body 61, electrical equipment including the lighting equipment, air-conditioning equipment 65, and ventilation equipment 64, and electricity usage measuring device 68 that measures the usage amount of electricity used by the electrical equipment. If such private booth unit 60 is used for teleworking, it is possible to more accurately measure the usage amount of electricity used during teleworking (which is approximately the emission amount of greenhouse gases generated during teleworking). Stated differently, incentive provision system 10 may include such private booth unit 60.

Many detached houses in the ASEAN region are built using the conventional method of stacking concrete bricks, due to which the thermal insulation performance is poor. Considering the hot and humid climate of the ASEAN region, the cooling efficiency of detached houses in the region is not sufficient, posing a problem that the usage amount of electricity used by air-conditioning equipment for teleworking during the day increases.

To cope with such a problem, the usage amount of electricity used by the air-conditioning equipment in detached houses in the ASEAN region will be reduced by adopting, in the houses, private booth unit 60 having relatively high heat insulation performance.

Note that, when private booth unit 60 is provided in the residence where the target person lives, it is possible for server device 40 to obtain the usage amount of electricity used by the target person while working from home by communicating with private booth unit 60. This communication is performed via communication device 27, for example, but it is possible to omit communication device 27 if the private booth unit is integrated with a communication device corresponding to communication device 27.

### Variation

The method of calculating the reference value and the method of calculating the personal value in the foregoing embodiment are mere examples. The reference value and the personal value are simply required to be calculated to enable the reference value and the personal value to be appropriately compared. It is thus not essential to precisely calculate the emission amount of greenhouse gases corresponding to the reference value and the emission amount of greenhouse gases corresponding to the personal value.

In the foregoing embodiment, for example, the emission amount of greenhouse gases related to meals is considered for the reference value and the personal value, but the emission amount of greenhouse gases related to meals may be excluded in calculating the reference value and in calculating the personal value, assuming that the emission amount of greenhouse gases related to meals is the same between the cases where the target person commutes to the facility to work and where the target person works from home.

Also, in the foregoing embodiment, all of electricity, water, and gas are considered in calculating the emission amount of greenhouse gases related to the workplace, but at least one of electricity, water, or gas is simply required to be considered. In calculating the emission amount of greenhouse gases related to the workplace, for example, only some of the items, among electricity, water, and gas that are likely to cause a difference between the cases where the target person commutes to the facility to work and where the target person works from home (e.g., the usage amount of electricity) may be considered.

Also, in the foregoing embodiment, the emission amount of greenhouse gases related to meals used in calculating the reference value is calculated assuming that employees use the cafeteria, but the emission amount of the employees not using the cafeteria may be separately calculated.

Note that the emission amount for the case where an employee eats out can be calculated by calculating (the annual emission amount of greenhouse gases generated by the entire company operating a restaurant where the employee eats out)/(the annual sales of such company)×(the prices of the menus ordered by the employee).

Also, in the foregoing embodiment, the incentive is money, but may take other forms than money, such as personnel evaluation.

### Effects, Etc.

The following shows example inventions achieved from the descriptions disclosed by this DESCRIPTION, and describes effects, etc. achieved from such example inventions.

Invention 1 is an incentive provision method executed by a computer. The incentive provision method includes: calculating step S25 of calculating an emission amount of greenhouse gas generated by a target person while working from home; and providing step S26 of providing an incentive to the target person in accordance with a difference between the emission amount calculated and a reference value, when the emission amount calculated is smaller than the reference value. The computer here is, for example, incentive provision system 10 (server device 40).

Such incentive provision method provides an incentive to the target person when the calculated emission amount of the greenhouse gas is smaller than the reference value, thereby reducing greenhouse gases generated by the target person while working from home.

Invention 2 is the incentive provision method according to Invention 1, wherein the target person is one of a plurality of employees who commute to a facility to work, and the reference value is: an emission amount of greenhouse gas per person assuming that the plurality of employees commute to the facility to work; and calculated based on a total of at least one of an emission amount of greenhouse gas related to commuting, an emission amount of greenhouse gas related to a meal, or an emission amount of greenhouse gas related to a workplace.

Such incentive provision method uses, as the reference value, the emission amount of the greenhouse gas per person that is calculated assuming that the plurality of employees commute to the facility to work, and is capable of calculating the reference value in consideration of the emission amount of the greenhouse gas related to at least one of commuting, meal, or workplace.

Invention 3 is the incentive provision method according to Invention 2, wherein the reference value is calculated using the emission amount of the greenhouse gas related to the workplace, and the emission amount of the greenhouse gas related to the workplace is calculated based on a usage amount of energy and a usage amount of water in the facility.

Such incentive provision method is capable of calculating the reference value in consideration of the emission amount of greenhouse gases related to the workplace.

Invention 4 is the incentive provision method according to Invention 2 or 3, wherein the reference value is calculated using the emission amount of the greenhouse gas related to the commuting, and the emission amount of the greenhouse gas related to the commuting is calculated based on an emission amount of greenhouse gas for each means of transportation used for the commuting.

Such incentive provision method is capable of calculating the reference value in consideration of the emission amount of the greenhouse gas related to the commuting. More specifically, the incentive provision method is capable of calculating the reference value in consideration of the emission amount of the greenhouse gas for each means of transportation used for the commuting.

Invention 5 is the incentive provision method according to any one of Inventions 2 to 4, wherein the reference value is calculated using the emission amount of the greenhouse gas related to the meal, and the emission amount of the greenhouse gas related to the meal is calculated based on an emission amount of greenhouse gas generated during production of an ingredient and an emission amount of greenhouse gas generated during cooking of the ingredient.

Such incentive provision method is capable of calculating the reference value in consideration of the emission amount of the greenhouse gas related to the meal. More specifically, the incentive provision method is capable of calculating the reference value in consideration of the emission amount of the greenhouse gas generated during the production of the ingredient and the emission amount of the greenhouse gas generated during the cooking of the ingredient.

Invention 6 is the incentive provision method according to any one of Inventions 2 to 5, wherein the incentive is an amount of money that is less than an allowance to be paid per person assuming that the plurality of employees commute to the facility to work.

Such incentive provision method is capable of providing money to the target person as an incentive.

Invention 7 is the incentive provision method according to any one of Inventions 1 to 6, further including obtaining step 21 of obtaining a usage amount of energy and a usage amount of water used by the target person while working from home, wherein the calculating step S25 includes calculating the emission amount of the greenhouse gas based on the usage amount of energy and the usage amount of water that have been obtained.

Such incentive provision method is capable of calculating the emission amount of the greenhouse gas (personal value), on the basis of the usage amount of energy and the usage amount of water used by the target person while working from home.

Invention 8 is the incentive provision method according to Invention 7, wherein the obtaining step S21 includes obtaining, through communication with private booth unit 60, a usage amount of electricity used by the target person while working from home, private booth unit 60 being occupied by the target person when working from home.

Such incentive provision method is capable of obtaining the usage amount of electricity used by the target person while working from home, by communicating with private booth unit 60.

Invention 9 is the incentive provision method according to Invention 8, wherein private booth unit 60 includes private booth main body 61, electrical equipment, and electrical usage measuring device 68 in an integrated manner, the electrical equipment including lighting equipment, air-conditioning equipment 63, and ventilation equipment 64, electrical usage measuring device 68 being a device that measures a usage amount of electricity used by the electrical equipment.

Such incentive provision method is capable of obtaining the usage amount of electricity used by the target person while working from home, by communicating with private booth unit 60 that is well-equipped for working from home.

Invention 10 is a program for causing a computer to execute the incentive provision method according to any one of Inventions 1 to 9.

According to such program, it is possible for the computer to reduce greenhouse gases generated by the target person while working from home.

### Other Embodiments

The embodiment has been described above, but the present invention is not limited to such embodiment.

In the foregoing embodiment, for example, the incentive provision system is realized using a plurality of devices. In this case, the elements included in the incentive provision system may be allocated to the plurality of devices in any manner. Also, the incentive provision system may be realized in the form of a single device such as, for example, a single device equivalent to the server device.

In addition, the communication method between devices in the foregoing embodiment is not limited to a specific method. Also, a relay device not shown may be interposed between devices in communication.

Also, in the foregoing embodiment, a process performed by a specified processing unit may be performed by another processing unit. Also, the processing order of a plurality of processes may be changed, and a plurality of processes may be performed in parallel.

Also, in the foregoing embodiment, each of the elements may be realized by executing a software program suitable for the element. Each of the elements may be realized by means of a program executing unit, such as a CPU and a processor, reading and executing the software program recorded on a recording medium such as a hard disk or a semiconductor memory.

Also, each of the elements may be realized in the form of a hardware product. Each of the elements may be, for example, a circuit (or integrated circuit). These circuits may form a single circuit as a whole, or in the form of individual circuits. Each of these circuits may be a general-purpose circuit or an exclusive circuit.

These general or specific aspects of the present invention may be implemented using a system, a device, a method, an integrated circuit, a computer program, or a recording medium such as a computer-readable CD-ROM. These general or specific aspects of the present invention may also be implemented using any combination of systems, devices, methods, integrated circuits, computer programs, or recording media.

For example, the present invention may be realized in the form of a method executed by a computer such as the incentive provision system in the foregoing embodiment, or may be realized in the form of a program (computer program product) for causing the computer to execute such method. The present invention may also be realized in the form of a non-transitory computer-readable recording medium having recorded thereon such program.

The present invention also includes an embodiment achieved by making various modifications to each embodiment that can be conceived by those skilled in the art or an embodiment achieved by freely combining elements and functions in each embodiment, without departing from the essence of the present invention.

### REFERENCE SIGNS LIST

10 incentive provision system
20 housing equipment group
21, 31 electrical equipment
22, 32, 68 electrical usage measuring device
23, 33 gas equipment
24, 34 gas usage measuring device
25, 35 water supply equipment
26, 36 water usage measuring device
27, 37 communication device
30 facility equipment group
40 server device
41 communicator
42 information processor
43 storage
44 obtainer
45 calculator
46 provider
47 outputter
50 information terminal
60 private booth unit
61 private booth main body
61a window
61b desk
61c chair
62 ambient lighting
63 task lighting
64 ventilation equipment
65 air-conditioning equipment
66 environmental sensor
67 remote control
80 wide-area communication network

1. An incentive provision method executed by a computer, the incentive provision method comprising:
calculating an emission amount of greenhouse gas generated by a target person while working from home; and
providing an incentive to the target person in accordance with a difference between the emission amount calculated and a reference value, when the emission amount calculated is smaller than the reference value.

2. The incentive provision method according to claim 1,
wherein the target person is one of a plurality of employees who commute to a facility to work, and
the reference value is:
an emission amount of greenhouse gas per person assuming that the plurality of employees commute to the facility to work; and
calculated based on a total of at least one of an emission amount of greenhouse gas related to commuting, an emission amount of greenhouse gas related to a meal, or an emission amount of greenhouse gas related to a workplace.

3. The incentive provision method according to claim 2,
wherein the reference value is calculated using the emission amount of the greenhouse gas related to the workplace, and
the emission amount of the greenhouse gas related to the workplace is calculated based on a usage amount of energy and a usage amount of water in the facility.

4. The incentive provision method according to claim 2,
wherein the reference value is calculated using the emission amount of the greenhouse gas related to the commuting, and
the emission amount of the greenhouse gas related to the commuting is calculated based on an emission amount of greenhouse gas for each means of transportation used for the commuting.

5. The incentive provision method according to claim 2,
wherein the reference value is calculated using the emission amount of the greenhouse gas related to the meal, and
the emission amount of the greenhouse gas related to the meal is calculated based on an emission amount of greenhouse gas generated during production of an ingredient and an emission amount of greenhouse gas generated during cooking of the ingredient.

6. The incentive provision method according to claim 2,
wherein the incentive is an amount of money that is less than an allowance to be paid per person assuming that the plurality of employees commute to the facility to work.

7. The incentive provision method according to claim 1, further comprising:
obtaining a usage amount of energy and a usage amount of water used by the target person while working from home,
wherein the calculating includes calculating the emission amount of the greenhouse gas based on the usage amount of energy and the usage amount of water that have been obtained.

8. The incentive provision method according to claim 7,
wherein the obtaining includes obtaining, through communication with a private booth unit, a usage amount of electricity used by the target person while working from home, the private booth unit being occupied by the target person when working from home.

9. The incentive provision method according to claim 8,
wherein the private booth unit includes a private booth main body, electrical equipment, and a measuring device in an integrated manner, the electrical equipment including lighting equipment, air-conditioning equipment, and ventilation equipment, the measuring device being a device that measures a usage amount of electricity used by the electrical equipment.

10. A non-transitory computer-readable recording medium having recorded thereon a program for causing the computer to execute the incentive provision method according to claim 1.
